(19) United States
(12) Patent Application Publication
(10) Pub. No.: US 2011/0077044 A1
(43) Pub. Date: Mar. 31, 2011

(54) POWER CONTROL FOR WIRELESS LAN STATIONS

(75) Inventors: Hemanth Sampath, San Diego, CA (US); Simone Merlin, San Diego, CA (US); Sameer Vermani, San Diego, CA (US)

(73) Assignee: QUALCOMM INCORPORATED, San Diego, CA (US)

(21) Appl. No.: 12/963,918

(22) Filed: Dec. 9, 2010

Related U.S. Application Data
(63) Continuation-in-part of application No. 12/352,733, filed on Jan. 13, 2009.
(60) Provisional application No. 61/312,428, filed on Mar. 10, 2010.
(60) Provisional application No. 61/090,365, filed on Aug. 20, 2008.

(51) Int. Cl. H04B 7/00

(52) U.S. Cl. 455/522

(57) ABSTRACT

Techniques and apparatus for controlling the transmit power of an uplink (UL) signal from a user terminal in a wireless communications system in an effort to achieve some target characteristic, such as a target carrier-to-interference (C/I) ratio, at an access point (AP) are provided. In this manner, such a user terminal may help avoid or compensate for imbalances in received radio frequency (RF) power between UL signals received from multiple user terminals by the AP. For example, the transmit power at each user terminal may be controlled in an effort to achieve a target post-processing C/I ratio of 28 dB per spatial stream in an effort to reduce large power imbalances and optimize throughput per user terminal The user terminal and the AP may compose part of a multiple-input multiple-output (MIMO) communication system utilizing spatial-division multiple access (SDMA) techniques.

### CROSS-REFERENCE TO RELATED APPLICATION

This application claims benefit of U.S. Provisional Patent Application Serial No. 61/312,428, entitled “Power Control Mechanism for Uplink Multiuser MIMO”, filed Mar. 10, 2010 and is a continuation-in-part of U.S. patent application Ser. No. 12/352,733, entitled “Power Control for Wireless LAN Stations”, filed Jan. 13, 2009, which claims benefit of U.S. Provisional Patent Application Ser. No. 61/090,365, entitled “Power Control for SDMA Stations”, filed Aug. 20, 2008, all of which are herein incorporated by reference in their entirety.

### FIELD

Certain embodiments of the present disclosure generally relate to wireless communication using multi-antenna transmission for spatial division multiple access (SDMA) in a multiple-input multiple-output (MIMO) communication system and, more specifically, to controlling the power of uplink (UL) signals from multiple SDMA stations in such a system.

### BACKGROUND

In order to address the issue of increasing bandwidth requirements demanded for wireless communication systems, different schemes are being developed to allow multiple user terminals to communicate with a single base station by sharing the same channel (same time and frequency resources) while achieving high data throughputs. Spatial Division Multiple Access (SDMA) represents one such approach that has recently emerged as a popular technique for the next generation communication systems. SDMA techniques may be adopted in several emerging wireless communications standards such as IEEE 802.11 (IEEE is the acronym for the Institute of Electrical and Electronic Engineers, 3 Park Avenue, 17th floor, New York, N.Y.) and Long Term Evolution (LTE).

In SDMA systems, a base station may transmit or receive different signals to or from a plurality of mobile user terminals at the same time and using the same frequency. In order to achieve reliable data communication, user terminals may need to be located in sufficiently different directions. Independent signals may be simultaneously transmitted from each of multiple space-separated antennas at the base station. Consequently, the combined transmissions may be directional, i.e., the signal that is dedicated for each user terminal may be relatively strong in the direction of that particular user terminal and sufficiently weak in directions of other user terminals. Similarly, the base station may simultaneously receive on the same frequency the combined signals from multiple user terminals through each of multiple antennas separated in space, and the combined received signals from the multiple antennas may be split into independent signals transmitted from each user terminal by applying the appropriate signal processing technique.

A multiple-input multiple-output (MIMO) wireless system employs a number (N_{T}) of transmit antennas and a number (N_{R}) of receive antennas for data transmission. A MIMO channel formed by the N_{T} transmit and N_{R} receive antennas may be decomposed into N_{S} spatial channels, where, for all practical purposes, N_{S}≦min {N_{T},N_{R}}. The N_{S} spatial channels may be used to transmit N_{S} independent data streams to achieve greater overall throughput.

In a multiple-access MIMO system based on SDMA, an access point can communicate with one or more user terminals at any given moment. If the access point communicates with a single user terminal, then the N_{T} transmit antennas are associated with one transmitting entity (either the access point or the user terminal), and the N_{R} receive antennas are associated with one receiving entity (either the user terminal or the access point). The access point can also communicate with multiple user terminals simultaneously via SDMA. For SDMA, the access point utilizes multiple antennas for data transmission and reception, and each of the user terminals typically utilizes less than the number of access point antennas for data transmission and reception. When SDMA is transmitted from an access point, N_{S}≦min {N_{T}, sum(N_{R})}, where sum(N_{R}) represents the summation of all user terminal receive antennas. When SDMA is transmitted to an access point, N_{S}≦min {sum(N_{T}), N_{R}}, where sum(N_{T}) represents the summation of all user terminal transmit antennas.

Orthogonal Frequency Division Multiple Access (OFDMA) is another technique for allowing multiple user terminals to communicate with a single base station. In an OFDMA-based system, multiple user terminals may communicate on different OFDM subcarriers (i.e., different frequencies) to a base station.

### SUMMARY

Certain embodiments of the present disclosure provide a method for wireless communication. The method generally includes receiving a plurality of uplink (UL) signals, determining power of the received plurality of UL signals, determining adjustment information for a UL signal in the plurality of UL signals based on at least the power of the received UL signals and a target carrier-to-interference (C/I) ratio, and transmitting the adjustment information.

Certain embodiments of the present disclosure provide a computer-program product for wireless communications. The computer-program product typically includes a computer-readable medium having instructions stored thereon, the instructions being executable by one or more processors. The instructions generally include instructions for receiving a plurality of UL signals, instructions for determining power of the received plurality of UL signals, instructions for determining adjustment information for a UL signal in the plurality of UL signals based on at least the power of the received UL signals and a target C/I ratio, and instructions for transmitting the adjustment information.

Certain embodiments of the present disclosure provide an apparatus for wireless communications. The apparatus generally includes means for receiving a plurality of UL signals, means for determining power of the received plurality of UL signals, means for determining adjustment information for a UL signal in the plurality of UL signals based on at least the power of the received UL signals and a target C/I ratio, and means for transmitting the adjustment information.

Certain embodiments of the present disclosure provide an access point (AP). The AP generally includes a receiver configured to a plurality of UL signals, logic for determining power of the received plurality of UL signals, logic for determining adjustment information for a UL signal in the plurality of UL signals based on at least the power of the received UL signals and a target C/I ratio, and a transmitter configured to transmit the adjustment information.

### BRIEF DESCRIPTION OF THE DRAWINGS

So that the manner in which the above recited features of the present disclosure can be understood in detail, a more particular description, briefly summarized above, may be had by reference to embodiments, some of which are illustrated in the appended drawings. It is to be noted, however, that the appended drawings illustrate only certain typical embodiments of this disclosure and are therefore not to be considered limiting of its scope, for the description may admit to other equally effective embodiments.

FIG. 1 illustrates a spatial division multiple access (SDMA) multiple-input multiple-output (MIMO) wireless system, in accordance with certain embodiments of the present disclosure.

FIG. 2 illustrates a block diagram of an access point (AP) and two user terminals, in accordance with certain embodiments of the present disclosure.

FIG. 3 illustrates various components that may be utilized in a wireless device, in accordance with certain embodiments of the present disclosure.

FIG. 4 illustrates performance degradation in an interleaved OFDMA scheme for multiple users, in accordance with certain embodiments of the present disclosure.

FIG. 5 illustrates example operations for open loop (and optional closed loop) power control of an uplink (UL) signal from the perspective of a user terminal, in accordance with certain embodiments of the present disclosure.

FIG. 5A is a block diagram of means corresponding to the example operations of FIG. 5 for UL signal power control, in accordance with certain embodiments of the present disclosure.

FIGS. 6A and 6B illustrate transmissions of power control information of an access station, in accordance with certain embodiments of the present disclosure.

FIG. 7 illustrates example operations for closed loop power control of a UL signal from the perspective of an AP, in accordance with certain embodiments of the present disclosure.

FIG. 7A is a block diagram of means corresponding to the example operations of FIG. 7 for controlling the power of a UL signal from the perspective of an AP, in accordance with certain embodiments of the present disclosure.

FIG. 8 illustrates example operations for power control of a UL signal based on the power of a plurality of received UL signals from the perspective of an AP, in accordance with certain embodiments of the present disclosure.

FIG. 8A is a block diagram of means corresponding to the example operations of FIG. 8 for controlling the power of a UL signal from the perspective of an AP, in accordance with certain embodiments of the present disclosure.

FIGS. 9-11 illustrate various examples of applying a power control mechanism for UL multiuser MIMO (UL-MU-MIMO), in accordance with certain embodiments of the present disclosure.

FIG. 12 illustrates an example UL-MU-MIMO protocol that may be used for power control of the UL signals, in accordance with certain embodiments of the present disclosure.

### DETAILED DESCRIPTION

Certain embodiments of the present disclosure provide techniques and apparatus for controlling the transmit power of an uplink (UL) signal from a user terminal in a wireless communications system in an effort to achieve some target characteristic, such as a target carrier-to-interference (C/I) ratio, at an access point (AP). In this manner, such a user terminal may help avoid or compensate for imbalances in received radio frequency (RF) power between UL signals received from multiple user terminals by the AP. For example, the transmit power at each user terminal may be controlled in an effort to achieve a target post-processing C/I ratio of 28 dB per spatial stream in an effort to reduce large power imbalances and optimize throughput per user terminal The user terminal and the AP may compose part of a multiple-input multiple-output (MIMO) communication system utilizing spatial-division multiple access (SDMA) techniques.

The word “exemplary” is used herein to mean “serving as an example, instance, or illustration.” Any embodiment described herein as “exemplary” is not necessarily to be construed as preferred or advantageous over other embodiments. Also as used herein, the term “legacy stations” generally refers to wireless network nodes that support 802.11n or earlier versions of the IEEE 802.11 standard.

The multi-antenna transmission techniques described herein may be used in combination with various wireless technologies such as Code Division Multiple Access (CDMA), Orthogonal Frequency Division Multiplexing (OFDM), Time Division Multiple Access (TDMA), and so on. Multiple user terminals can concurrently transmit/receive data via different (1) orthogonal code channels for CDMA, (2) time slots for TDMA, or (3) sub-bands for OFDM. A CDMA system may implement IS-2000, IS-95, IS-856, Wideband-CDMA (W-CDMA), or some other standards. An OFDM system may implement IEEE 802.11 or some other standards. A TDMA system may implement GSM or some other standards. These various standards are known in the art.

### An Example MIMO System

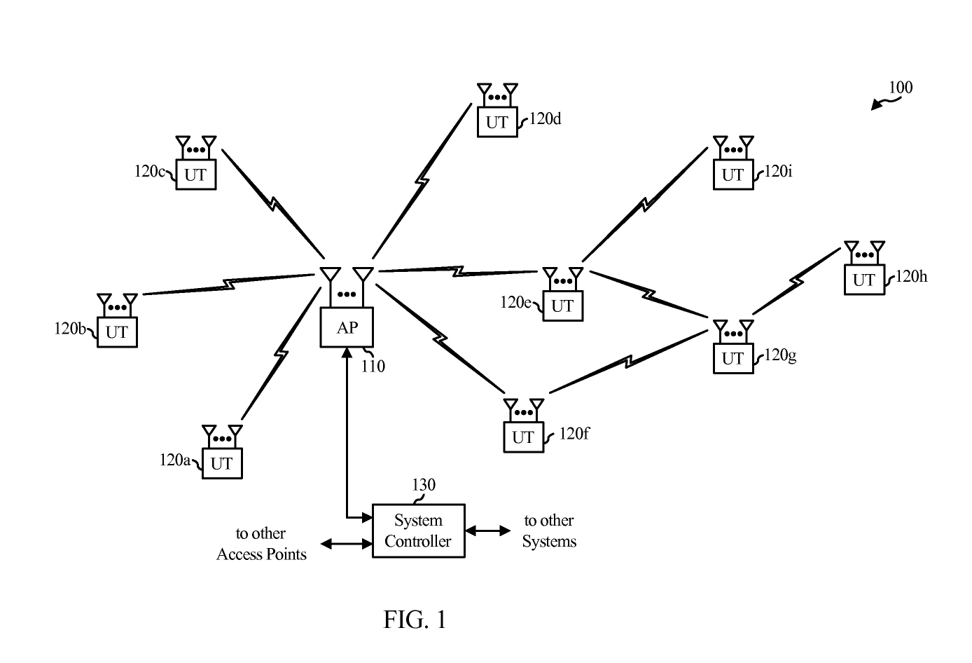

FIG. 1 shows a multiple-access MIMO system 100 with access points and user terminals. For simplicity, only one access point 110 is shown in FIG. 1. An access point (AP) is generally a fixed station that communicates with the user terminals and may also be referred to as a base station or some other terminology. A user terminal (UT) may be fixed or mobile and may also be referred to as a mobile station (MS), a station (STA), or some other terminology. A user terminal may be a wireless device, such as a cellular phone, a personal digital assistant (PDA), a handheld device, a wireless modem, a laptop computer, a personal computer, etc.

Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

While portions of the following disclosure will describe user terminals 120 capable of communicating via spatial division multiple access (SDMA), for certain embodiments, the user terminals 120 may also include some user terminals that do not support SDMA. Thus, for such embodiments, an AP 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

System 100 employs multiple transmit and multiple receive antennas for data transmission on the downlink and uplink. Access point 110 is equipped with a number Nₐₚ of antennas and represents the multiple-input (MI) for downlink transmissions and the multiple-output (MO) for uplink transmissions. A set Nᵤ of selected user terminals 120 collectively represents the multiple-output for downlink transmissions and the multiple-input for uplink transmissions. For pure SDMA, it is desired to have Nₐₚ≧Nᵤ≧1 if the data symbol streams for the Nᵤ user terminals are not multiplexed in code, frequency, or time by some means. Nᵤ may be greater than Nₐₚ if the data symbol streams can be multiplexed using different code channels with CDMA, disjoint sets of sub-bands with OFDM, and so on. Each selected user terminal transmits user-specific data to and/or receives user-specific data from the access point. In general, each selected user terminal may be equipped with one or multiple antennas (i.e., Nᵤₜ≧1). The Nᵤ selected user terminals can have the same or different number of antennas.

MIMO system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported).

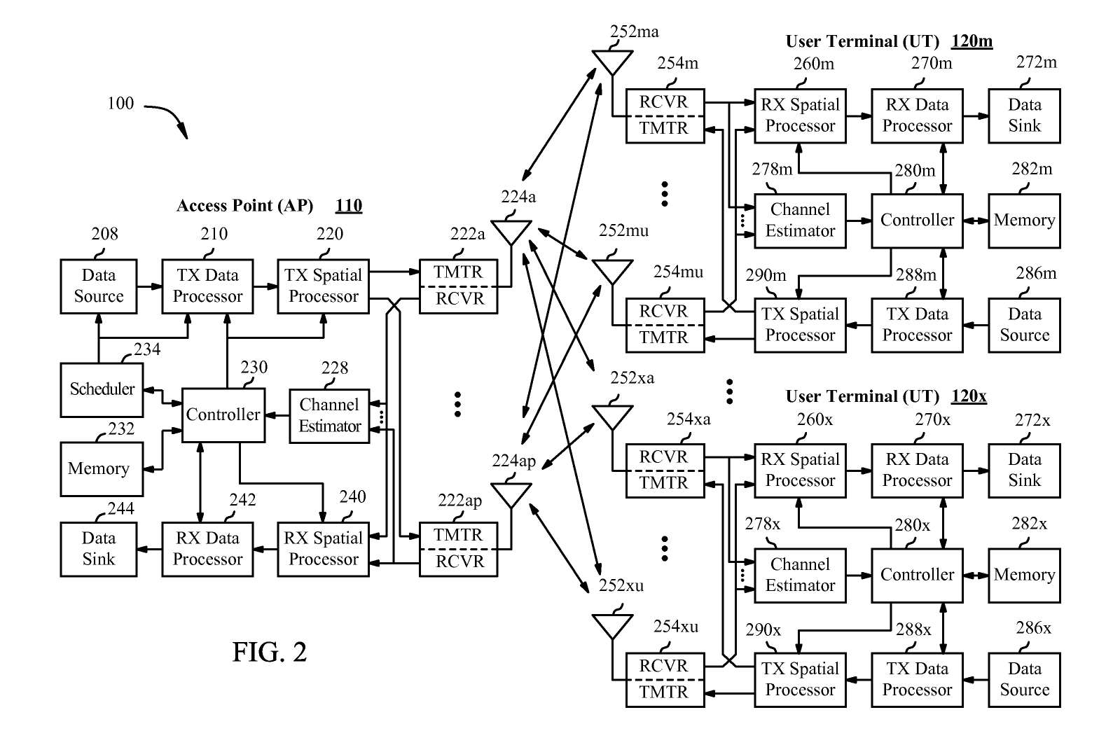

FIG. 2 shows a block diagram of access point 110 and two user terminals 120m and 120x in MIMO system 100. Access point 110 is equipped with Nₐₚ antennas 224a through 224ap. User terminal 120m is equipped with N_{ut,m} antennas 252ma through 252mu, and user terminal 120x is equipped with N_{ut,x} antennas 252xa through 252xu. Access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each user terminal 120 selected for uplink transmission, a TX data processor 288 receives traffic data from a data source 286 and control data from a controller 280. TX data processor 288 processes (e.g., encodes, interleaves, and modulates) the traffic data {d_{up,m}} for the user terminal based on the coding and modulation schemes associated with the rate selected for the user terminal and provides a data symbol stream {s_{up,m}}. A TX spatial processor 290 performs spatial processing on the data symbol stream {s_{up,m}} and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point 110.

A number Nᵤₚ of user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), successive interference cancellation (SIC), or some other technique. Each recovered uplink data symbol stream {s_{up,m}} is an estimate of a data symbol stream {s_{up,m}} transmitted by a respective user terminal An RX data processor 242 processes (e.g., demodulates, deinterleaves, and decodes) each recovered uplink data symbol stream {s_{up,m}} in accordance with the rate used for that stream to obtain decoded data. The decoded data for each user terminal may be provided to a data sink 244 for storage and/or a controller 230 for further processing.

On the downlink, at access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal TX data processor 210 provides N_{dn} downlink data symbol streams for the N_{dn} user terminals. A TX spatial processor 220 performs spatial processing on the N_{dn} downlink data symbol streams, and provides Nₐₚ transmit symbol streams for the Nₐₚ antennas. Each transmitter unit (TMTR) 222 receives and processes a respective transmit symbol stream to generate a downlink signal. Nₐₚ transmitter units 222 provide Nₐₚ downlink signals for transmission from Nₐₚ antennas 224 to the user terminals.

At each user terminal 120, N_{ut,m} antennas 252 receive the Nₐₚ downlink signals from access point 110. Each receiver unit (RCVR) 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream {s_{dn,m}} for the user terminal The receiver spatial processing is performed in accordance with the CCMI, MMSE, or some other technique. An RX data processor 270 processes (e.g., demodulates, deinterleaves, and decodes) the recovered downlink data symbol stream to obtain decoded data for the user terminal

At each user terminal 120, N_{ut,m} antennas 252 receive the Nₐₚ downlink signals from access point 110. Each receiver unit (RCVR) 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream {s_{dn,m}} for the user terminal The receiver spatial processing is performed in accordance with the CCMI, MMSE, or some other technique. An RX data processor 270 processes (e.g., demodulates, deinterleaves, and decodes) the recovered downlink data symbol stream to obtain decoded data for the user terminal

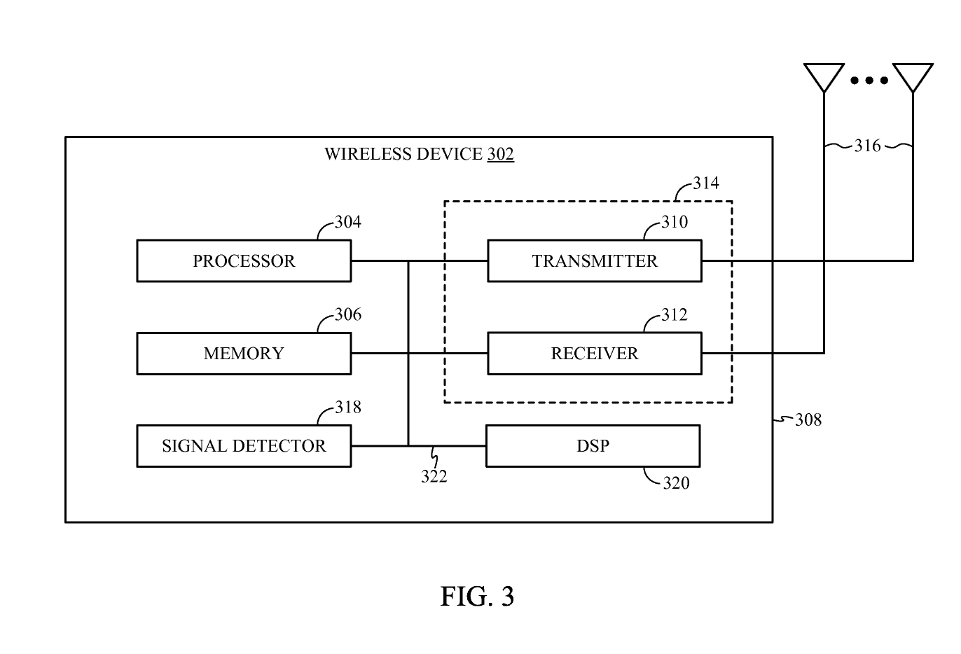

FIG. 3 illustrates various components that may be utilized in a wireless device 302 that may be employed within the system 100. The wireless device 302 is an example of a device that may be configured to implement the various methods described herein. The wireless device 302 may be an access point 110 or a user terminal 120.

The wireless device 302 may include a processor 304 which controls operation of the wireless device 302. The processor 304 may also be referred to as a central processing unit (CPU). Memory 206A, which may include both read-only memory (ROM) and random access memory (RAM), provides instructions and data to the processor 304. A portion of the memory 206A may also include non-volatile random access memory (NVRAM). The processor 304 typically performs logical and arithmetic operations based on program instructions stored within the memory 206A. The instructions in the memory 206A may be executable to implement the methods described herein.

The wireless device 302 may also include a housing 308 that may include a transmitter 310 and a receiver 312 to allow transmission and reception of data between the wireless device 302 and a remote location. The transmitter 310 and receiver 312 may be combined into a transceiver 314. A plurality of transmit antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

### Power Control for 802.11 Stations for Multiple Access

The next generation of the IEEE 802.11 standard is moving towards SDMA and Orthogonal Frequency-Division Multiple Access (OFDMA). These technologies include provisions for multiple stations (STAs) to be simultaneously transmitting to an access point (AP). However, large power imbalances in the received power from multiple stations may result in performance degradation due to signal-dependent RF noise floors and frequency offset. For example, each AP-STA link may have different frequency offsets, which may lead to inter-channel interference (ICI) distortion. The signal-dependent RF noise floors may arise from I-Q imbalance and RF nonlinearities in each STA.

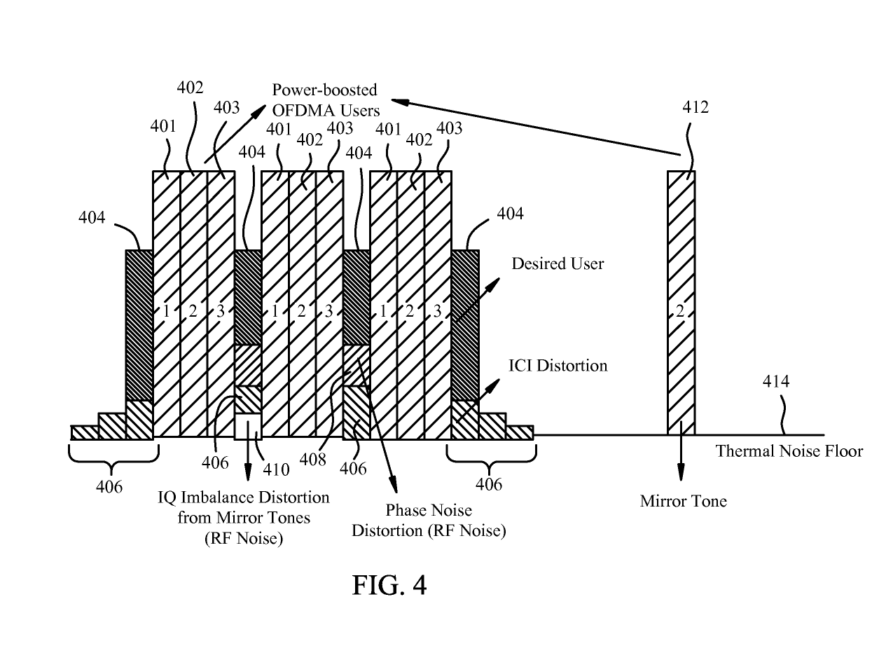

For example, FIG. 4 illustrates performance degradation in an interleaved OFDMA scheme with uplink (UL) signals from four users. In FIG. 4, three of the four user UL signal tones are power-boosted OFDMA UL signal tones 401, 402, 403, while the desired user UL signal 404 is not power-boosted in the same manner and, thus, has a lower power level. Such large uplink power differences across user terminals may lead to increased performance degradation for user terminals with lower received OFDMA signal power at the AP. To the first order, even larger performance degradation may be expected from SDMA power imbalances.

As shown, tones adjacent to power-boosted OFDMA (or SDMA) tones 401, 402, 403 may suffer from ICI distortion 406 (due to frequency offset error) and from phase noise distortion 408. Furthermore, tones 412 that are mirrors of power-boosted tones may suffer from I-Q imbalance distortion 410 above the thermal noise floor 414.

Accordingly, what is needed are techniques and apparatus for controlling the power of uplink signals from multiple user terminals in an effort to reduce power degradation at an access point, especially for user terminals with lower received signal power at the AP.

### Example Open Loop Power Control

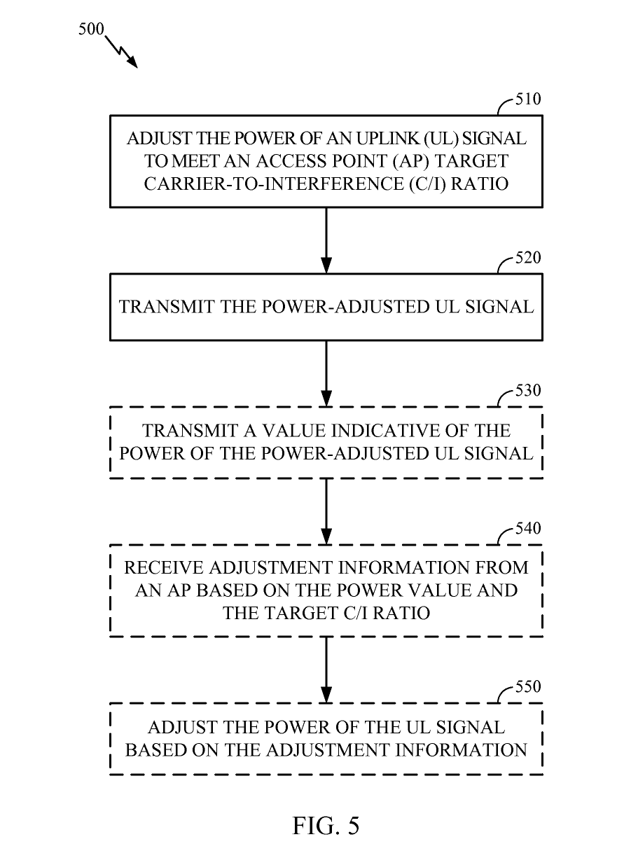

FIG. 5 illustrates example operations 500 for power control of a UL signal from the perspective of a user terminal, according to certain embodiments of the present disclosure. The operations 500 may begin, at 510, by adjusting the power of a UL signal to meet a target carrier-to-interference (C/I) ratio of an access point (AP). This adjustment at 510 may be performed by the user terminal upon reception of DL packets and prior to UL multiple access transmission. The AP's target C/I ratio may be a post-processing target such that the target C/I ratio reflects a desired C/I ratio of a UL signal received from any capable user terminal after reception and signal processing by the AP. For some embodiments, the transmit power of a UL signal may be adjusted to meet the AP target C/I ratio and a client peak power constraint.

For some embodiments, the target C/I ratio may be 28 dB per spatial stream in an effort to maximize throughput per user terminal Although a target C/I ratio of 28 dB may yield a heightened spectral efficiency, the target C/I ratio may change depending on the code-rate used. Furthermore, for link-budget limited user terminals, a C/I ratio of 28 dB may not be achievable due to power amplifier (PA) limitations in the transmitter.

To meet the target C/I ratio at the AP, the user terminal's transmit power (P_{client}) for the UL signal may be calculated at 510 according to the following formula:

P_{client}=SNR_{Target}−G_{OFDMA}−G_{SDMA}−G_{CDMA}+N_{TH}+C+P_{AP}−RSSI_{client}

where SNR_{Target} is the target C/I ratio at the AP, G_{OFDMA} is an optional orthogonal frequency-division multiple access (OFDMA) processing gain, G_{SDMA} is an optional spatial-division multiple access (SDMA) processing gain at the AP, G_{CDMA} is an optional code-division multiple access (CDMA) processing gain, N_{TH} is a thermal noise floor, C represents parameters calibrated during association or other representative packet exchange protocols, P_{AP} is an AP transmit power (e.g., advertised by the AP), and RSS_{client} is a received signal strength indication (RSSI) of a received downlink (DL) signal measured at the user terminal Some of these parameters may be calibrated out, and other parameters may be provided by the AP, for example.

The calculation for P_{client} may most likely include at least one of G_{OFDMA}, G_{SDMA}, and G_{CDMA}. G_{OFDMA} may be equal to 10 log₁₀ (64/Nₜₒₙₑₛ) where Nₜₒₙₑₛ is the number of frequencies used for transmission, and G_{SDMA} may be equal to 10 log₁₀ (M_{T}/N_{S}) where M_{T} is the number of transmit antennas and N_{S} is the number of SDMA spatial streams. The parameters calibrated during association or other representative packet exchange protocols may include, for example, a noise figure at the AP (NF_{AP}) and a radio frequency (RF)/antenna gain at the AP (G_{AP,RF}). Such parameters may be advertised by the AP.

At 520, the user terminal may transmit the power-adjusted UL signal. The transmitted signal may meet the calculated transmit power P_{client}, for example, unless the desired power exceeds the capabilities of the transmitter circuit components, such as the power amplifier. In this manner, the UL signal may be received by an AP and, after post-processing, may achieve the desired target C/I ratio. If multiple user terminals implement the operations at 510 and 520 described above in an effort to transmit multiple UL signals attempting to meet the desired AP target C/I ratio, there need not be large power differences between the UL signals received by the AP, and the performance degradation to UL signals with lower received signal power may most likely be reduced. In other words, according to certain embodiments of the present disclosure, by having the transmit power of UL signals from different user terminals adjusted to meet a target C/I ratio at the AP, significant differences in received UL signal power may be eliminated, and the effects of ICI distortion, phase distortion, and I-Q imbalance, for example, may be mitigated.

### Example Closed Loop Power Control

The operations at 510 and 520 may be considered as open loop power control operations because these operations adjust the transmit power of UL signals without feedback from the AP. However, as illustrated by optional operations at 530 to 550, closed loop operations (based on AP feedback) may also be performed. Closed loop power control may be employed in an effort to provide better power control and account for any imperfections in open loop power control due to, for example, an imperfect or outdated RSSI measurement and any changes to AP RF and processing gains. Further, closed loop power control may allow the AP to manage client transmit powers for optimum UL SDMA/OFDMA performance, police rogue clients (i.e., clients that are transmitting with excessive power, perhaps due to incorrect RSSI measurements or estimates), and limit interference generated to neighbor base station subsystems (BSSs), for example, in enterprise applications.

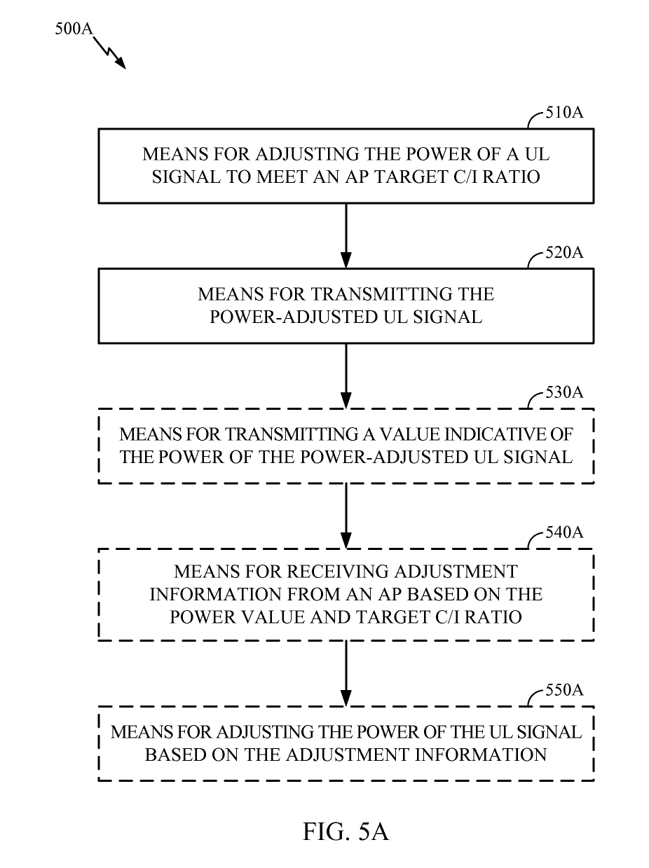

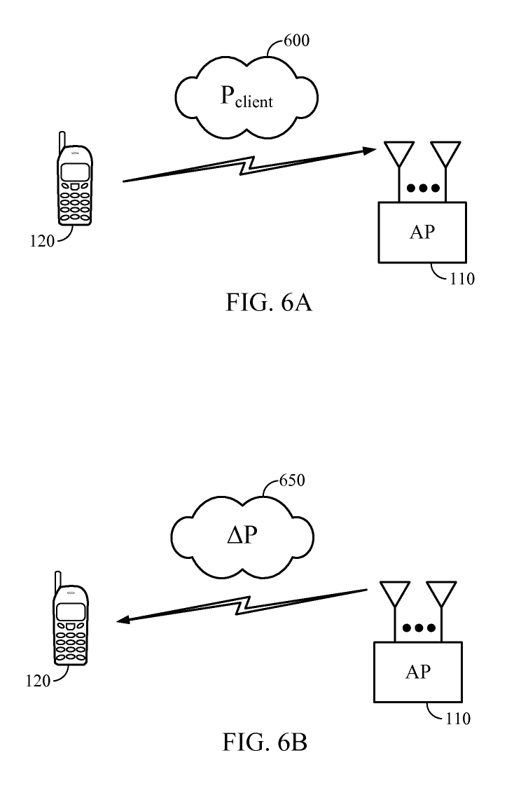

Therefore, for closed loop power control operations as illustrated in FIG. 6A, the user terminal 120 may transmit a value 600 (e.g., P_{client}) indicative of the power of the power-adjusted UL signal at 530. At 540, the user terminal 120 may receive adjustment information 650 (represented as ΔP) from the AP 110 as shown in FIG. 6B. For some embodiments, the adjustment information 650 may be based on the power value 600 and the target C/I ratio of the AP 110. For example, the adjustment information 650 may be a new, adjusted target C/I ratio (e.g., SNR′_{Target}) or an adjustment to the target C/I ratio (e.g., ΔSNR_{Target}) based on the difference between the target C/I ratio and the actual received C/I ratio after post-processing. At 550, the user terminal 120 may adjust the transmit power of the UL signal based on the adjustment information 650 received from the AP 110. For certain embodiments, the user terminal 120 may only adjust the transmit power of the UL signal if the difference between the target C/I ratio and the actual received C/I ratio is greater than a threshold.

For certain embodiments, the user terminal 120 may communicate the currently used transmit power value 600, such as P_{client}, in units of dBm, for example, to the AP 110 using an N-bit field in a Media Access Control (MAC) header of a UL packet such that bit values ranging from 0 to 2^{N}−1 indicate representative values. In such a scenario with N=6 as an example, the bit-representation may cover a range of [0:1:63] corresponding to a power value 600 ranging from [31 8.5:0.5:23.0] dBm, for example, with a resolution of 0.5 dBm, for some embodiments.

For other embodiments, the power value 600 communicated by the user terminal 120 may represent a back-off value from a peak transmit power. This feedback may allow the AP 110 to determine the amount of PA headroom available to the user terminal 120. Such information may be needed for DL closed-loop power control signaling for multiple stations. Hence, a range of [0:1:63] with N=6, for example, may correspond to a peak transmit power that is [0.0:0.5:31.5] dB below the peak transmit power with a resolution of 0.5 dB. The user terminal 120 may communicate the peak transmit power to the AP 110 during association, the initial handshake when the user terminal 120 first enters the network.

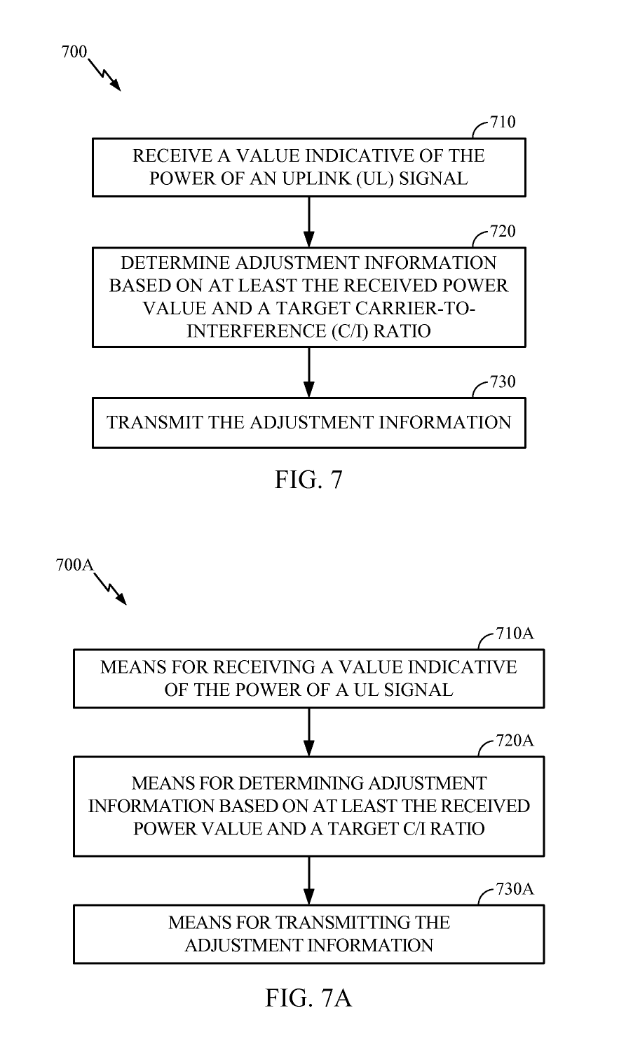

FIG. 7 illustrates example operations 700 for closed loop power control of a UL signal from the perspective of an AP 110. The operations 700 may begin, at 710, by receiving a value 600 (e.g., P_{client} as shown in FIG. 6A) indicative of the power of a UL signal transmitted by a user terminal 120. The AP 110 may be able to decode the power value in a MAC header of a received UL packet.

At 720, the AP 110 may determine adjustment information 650 based on at least the received power value 600 and a target C/I ratio. For example, the adjustment information 650 may be a new, adjusted target C/I ratio (e.g., SNR′_{target}) or an adjustment to the target C/I ratio (e.g., ΔSNR_{Target}) based on the difference between the target C/I ratio and the measured C/I ratio of the UL signal after reception at 710 and post-processing. For some embodiments, the AP target C/I ratio may be 28 dB per spatial stream as described above.

At 730, the AP 110 may transmit the adjustment information 650 (e.g., ΔP as shown in FIG. 6B) to the user terminal 120. To communicate the adjustment information 650, the AP 110 may encode the adjustment information 650 in a MAC header of a DL packet. For certain embodiments, the AP 110 may use an M-bit field in the MAC header of the DL packet such that bit values ranging from 0 to 2^{M}−1 indicate representative values. In such a scenario with M=6 as an example, thereby covering a range of [0:1:63], the bit-representation may correspond to an adjustment range of [−16.0:0.5:15.5] dBm for some embodiments.

For other embodiments, the adjustment information 650 communicated to the user terminal 120 may represent a back-off value from a peak transmit power. As noted above, the adjustment information 650 may take into account the PA headroom available to the user terminal 120. Hence, a range of [0:1:63] with M=6, for example, may correspond to a transmit power that is [0.0:0.5:31.5] dB below the peak transmit power with a resolution of 0.5 dB.

The operations 700 may be performed for multiple user terminals, each of which may provide a value indicative of transmit power used for UL transmissions. Thus, the AP may send different power adjustment information to different user terminals.

### Example Power Control For UL-MU-MIMO

As described above, large power imbalances in the received power from multiple user terminals 120 (or multiple STAs) may result in performance degradation. In other words, the multiple user terminals may have different path losses, and strong user terminals may cause interference with weaker ones. In a multiuser multiple-input multiple-output (MU-MIMO) scheme, user terminals 120 close to the AP 110 may interfere with user terminals further from the AP. For certain aspects, the AP 110 may determine the power of the received signals and a power correction value for each of the user terminals, and each user terminal 120 may apply the individual power correction value received from the AP.

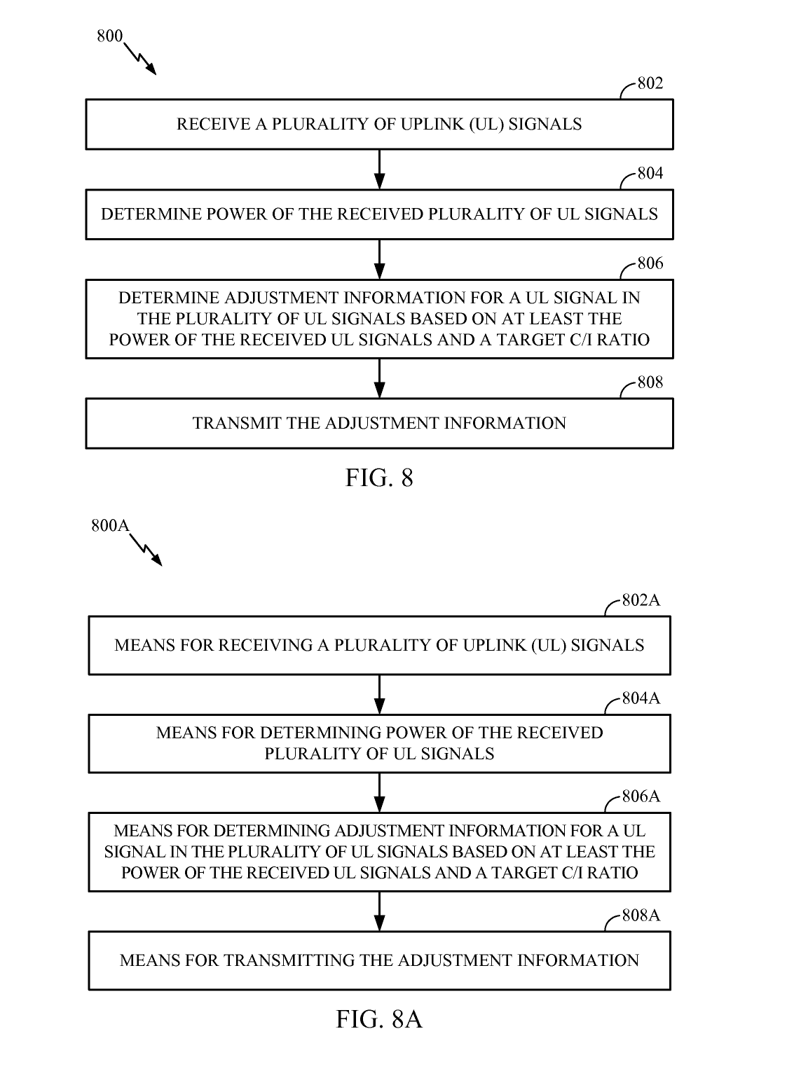

FIG. 8 illustrates example operations 800 for power control of an uplink (UL) signal based on the power of a plurality of received UL signals from the perspective of an AP, in accordance with certain embodiments of the present disclosure. The operations 800 may begin, at 802, by receiving a plurality of UL signals. For example, the plurality of UL signals may be UL signals received from at least some, if not all, the user terminals 120 that are part of a UL-MU-MIMO scheme.

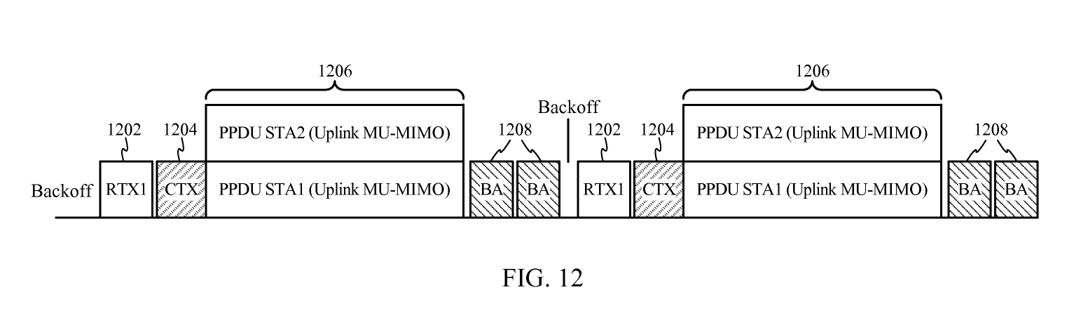

At 804, the AP 110 may determine power of the received plurality of UL signals. For example, the AP may measure the received power (Pᵢ) of each UL signal received from a user terminal 120 in a UL-MU-MIMO scheme. For certain aspects, these measurements may be taken from received RTX (Request to Transmit) messages 1202 and/or UL physical layer convergence protocol (PLCP) protocol data units (UL-PPDUs), both of which are illustrated in FIG. 12 and described in greater detail below.

At 806, the AP 110 may determine power adjustment information for a UL signal (e.g., a UL-MU-MIMO signal) in the plurality of UL signals based on at least the power of the received UL signals and a target C/I ratio. For certain aspects, the AP 110 may calculate a power back-off (Bᵢ) each user terminal should apply to the UL signal the particular user terminal is transmitting. The power back-off may be computed according to the following equation:

Bᵢ=Pᵢ−max [maxⱼ(Pⱼ)−MAX_BO, Noise_floor+SNR_{Target}]

where maxⱼ(Pⱼ) is the maximum received power of all the UL signals, MAX_BO is the maximum power back-off a user terminal can apply, Noise_floor is a measure of the thermal noise floor in dB, and SNR_{Target} is a target received power-to-noise ratio (e.g., the target C/I ratio at the AP). For example, MAX_BO may be about 30 or 40 dB, and SNR_{Target} may be about 28 or 30 dB. For certain aspects, Bᵢ may be bounded by a lower bound of 0 dB and an upper bound of MAX_BO in units of dB such that the power back-off can neither be negative, nor exceed the maximum power back-off. Also for certain aspects, Bᵢ may be quantized in increments of power control steps (PC_step), where PC_step may be around 3 dB, for example.

At 808, the AP 110 may transmit the power adjustment information. For example, the AP 110 may communicate Bᵢ to all the user terminals in the UL-MU-MIMO scheme, only to user terminals where Bᵢ is not zero, or only to user terminals where Bᵢ is above the quantized power control step (PC_step). For certain aspects, the AP 110 may transmit CTX (Clear to Transmit) messages 1204 (illustrated in FIG. 12 and described in greater detail below) with a field signaling the back-off value.

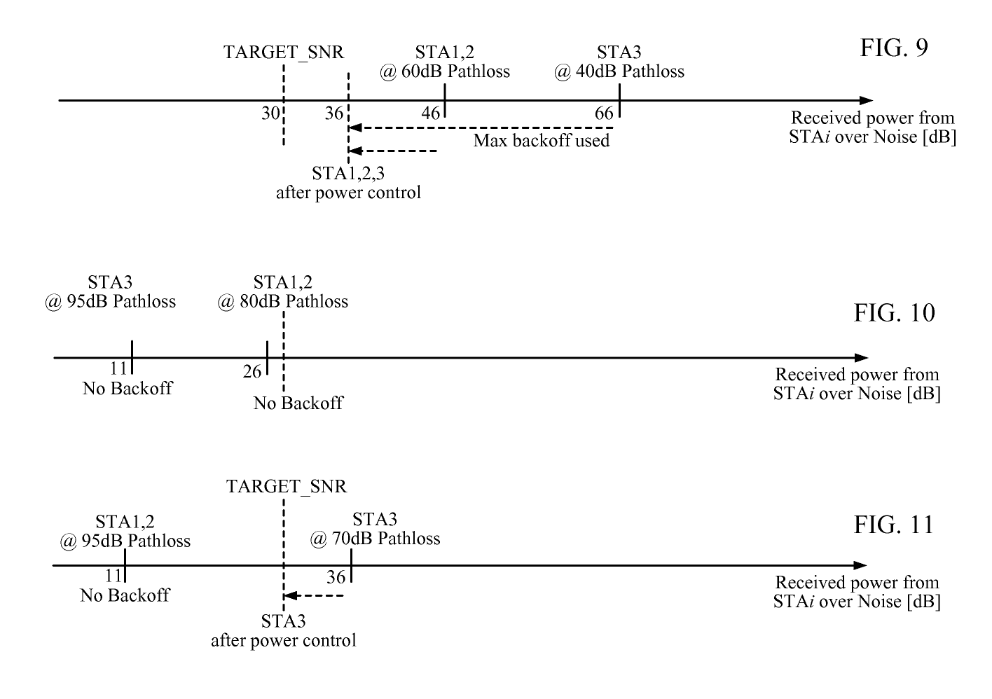

FIGS. 9-11 illustrate various examples of applying the power control mechanism described above to three stations (STA1, STA2, and STA3) based on the equation for calculating Bᵢ for each individual user terminal in a UL-MU-MIMO scheme. In all of these examples, MAX_BO is 30 dB, Noise_floor is negligent (0 dB), SNR_{Target} is 30 dB, and STA1, STA2, and STA3 all transmit with a power of 106 dB.

FIG. 9 illustrates a scenario where the received power (Pᵢ) from STA1, STA2, and STA3 are all above the target power-to-noise ratio (SNR_{Target}). The power transmitted from STA1 and STA2 experiences a pathloss of 60 dB, such that the received power at the AP 110 is 46 dB for both UL signals. The power transmitted from STA3 experiences a pathloss of only 40 dB, such that the received power at the AP is 66 dB for this UL signal. Calculating B₁ for STA1 and B₂ for STA2 according to the equation for B above leads to B₁=B₂=46−max [66−30, 0+30] dB=46−36=10 dB. Therefore, the AP may transmit B₁ to STA1 and B₂ to STA2 such that after STA1 and STA2 apply the back-off values, the received power of the UL signals at the AP may be 36 dB as illustrated. Calculating B₃ for STA3 results in B₃=66−max [66−30, 0+30] dB=66−36=30 dB. Therefore, the AP may transmit B₃ to STA3 such that after STA3 applies the back-off value, the received power of the UL signal at the AP may be 36 dB as illustrated.

In FIG. 9, note that the received power after power control for STA1, STA2, and STA3 are all equal such that none of the UL signals is stronger than another as received at the AP. Therefore, performance degradation due to power imbalance may most likely be reduced. Furthermore, note that the received power of the UL signals did not reach the target power-to-noise ratio. This is due to the maximum power back-off value a user terminal can apply (30 dB in this example).

FIG. 10 illustrates a scenario where the received power (Pᵢ) from STA1, STA2, and STA3 are all below the target power-to-noise ratio (SNR_{Target}). The power transmitted from STA1 and STA2 experiences a pathloss of 80 dB, such that the received power at the AP 110 is 26 dB for both UL signals. The power transmitted from STA3 experiences a pathloss of 95 dB, such that the received power at the AP is 11 dB for this UL signal. Calculating B₁ for STA1 and B₂ for STA2 according to the equation for Bᵢ above leads to B₁=B₂=26−max [26−30, 0+30] dB=26−30=−4 dB. However, Bᵢ is bounded with a lower bound of 0 dB, such that B₁=B₂=0 dB. Similarly, calculating B₃ for STA3 results in B₃=11−max [26−30, 0+30] dB=11−30=−19 dB, but B₃=0 dB due to the lower bound. Therefore, for certain aspects, the AP may not transmit any adjustment information to STA1, STA2, or STA3. For other aspects, the AP may transmit B₁ to STA1, B₂ to STA2, and B₃ to STA3 such that after STA1, STA2, and STA3 apply the back-off values of 0 dB, no back-off occurs. In other words, the received power of the UL signals at the AP may remain at 26 dB and 11 dB as illustrated in FIG. 10.

FIG. 11 illustrates a scenario where the received power (Pᵢ) from STA1 and STA2 are below the target power-to-noise ratio (SNR_{Target}), but the received power from STA3 is above SNR_{Target}. The power transmitted from STA1 and STA2 experiences a pathloss of 95 dB, such that the received power at the AP 110 is 11 dB for both UL signals. The power transmitted from STA3 experiences a pathloss of 70 dB, such that the received power at the AP is 36 dB for this UL signal. Calculating B₁ for STA1 and B₂ for STA2 according to the equation for Bᵢ above leads to B₁=B₂=11−max [36−30, 0+30] dB=11−30=−19 dB, but B₁=B₂=0 dB due to the lower bound as described above. Therefore, for certain aspects, the AP may not transmit any adjustment information to STA1 or STA2. For other aspects, the AP may transmit B₁ to STA1 and B₂ to STA2 such that after STA1 and STA2 apply the back-off values of 0 dB, no back-off occurs. In other words, the received power of the UL signals at the AP may remain at 11 dB as illustrated in FIG. 11.

Calculating B₃ for STA3 results in B₃=36−max [36−30, 0+30] dB=36−30=6 dB. Therefore, the AP may transmit B₃ to STA3 such that after STA3 applies the back-off value, the received power of the UL signal at the AP may be 30 dB as illustrated in FIG. 11. Note that since the difference between the received power for the UL signal transmitted by STA3 and the target power-to-noise ratio was within the maximum back-off value, STA3 was able to adjust the UL signal transmission power to meet the target ratio for the received power at the AP 110.

FIG. 12 illustrates an example UL-MU-MIMO protocol that may be used for power control of the UL signals, in accordance with certain embodiments of the present disclosure. The user terminals 120 may transmit RTX messages 1202 to request for UL-MU-MIMO transmission. For example, STA1 may send RTX1, and STA2 may send RTX2. The AP 110 may measure the power of a received RTX message to determine the power of a UL signal from a particular user terminal 120.

The AP 110 may respond to an RTX message with a CTX message 1204. The CTX message 1204 contains a list of user terminals 120 that can take part in the UL-MU-MIMO scheme, such that a particular user terminal knows to start a UL-MU-MIMO transmission. The AP may select user terminals with a simple round robin among a given set of user terminals. The CTX message 1204 may contain a field indicating the back-off value(s) (Bᵢ) for the user terminal(s) to apply to UL-MU-MIMO signal transmissions.

Once a user terminal 120 receives a CTX message 1204 from the AP where this user terminal is listed, the user terminal may transmit UL-MU-MIMO data 1206. In FIG. 12, STA1 and STA2 both transmit UL-MU-MIMO data 1206 containing physical layer convergence protocol (PLCP) protocol data units (PPDUs). Upon receiving the UL-MU-MIMO data 1206, the AP 110 may transmit block acknowledgments (BAs) 1208 to the user terminals 120.

With this power control scheme, user terminals operating in a UL-MU-MIMO scheme can each apply a back-off value determined by an AP up to a maximum back-off value when the power of UL signals received at the AP exceeds a target power-to-noise ratio. In this manner, performance degradation due to power imbalances may be reduced.

The various operations of methods described above may be performed by various hardware and/or software component(s) and/or module(s) corresponding to means-plus-function blocks illustrated in the figures. Generally, where there are methods illustrated in figures having corresponding counterpart means-plus-function figures, the operation blocks correspond to means-plus-function blocks with similar numbering. For example, blocks 510-550 illustrated in FIG. 5 correspond to means-plus-function blocks 510A-550A illustrated in FIG. 5A. Similarly, blocks 710-730 of FIG. 7 correspond to means-plus-function blocks 710A-730A illustrated in FIG. 7A.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

Information and signals may be represented using any of a variety of different technologies and techniques. For example, data, instructions, commands, information, signals, and the like that may be referenced throughout the above description may be represented by voltages, currents, electromagnetic waves, magnetic fields or particles, optical fields or particles, or any combination thereof

The various illustrative logical blocks, modules, and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communication, comprising:
receiving a plurality of uplink (UL) signals;
determining power of the received plurality of UL signals;
determining adjustment information for a UL signal in the plurality of UL signals based on at least the power of the received UL signals and a target carrier-to-interference (C/I) ratio; and
transmitting the adjustment information.

2. The method of claim 1, wherein receiving the plurality of UL signals comprises receiving a Request to Transmit (RTX) message or a physical layer convergence protocol (PLCP) protocol data unit (PPDU).

3. The method of claim 1, wherein the adjustment information for the UL signal comprises a back-off value for a station (STA) that transmitted the UL signal.

4. The method of claim 1, wherein determining the adjustment information comprises:
determining a maximum of the power of the received UL signals; and
determining the adjustment information for the UL signal based on the maximum power and the target C/I ratio.

5. The method of claim 4, wherein determining the adjustment information comprises:
determining a thermal noise floor power; and
determining the adjustment information for the UL signal based on the maximum power, the target C/I ratio, and the thermal noise floor power.

6. The method of claim 5, wherein determining the adjustment information comprises:
determining a maximum value between the maximum power of the received UL signals subtracted by a maximum back-off value and a sum of the thermal noise floor power and the target C/I ratio; and
subtracting the maximum value from the received power of the UL signal to calculate the adjustment information for the UL signal.

7. The method of claim 6, wherein the adjustment information is bounded by a lower bound of 0 and an upper bound equal to the maximum back-off value.

8. The method of claim 6, wherein the maximum back-off value is about 40 dB.

9. The method of claim 1, wherein the target C/I ratio is about 30 dB.

10. The method of claim 1, wherein transmitting the adjustment information comprises transmitting a Clear to Transmit (CTX) message with a field indicating the adjustment information for the UL signal.

11. The method of claim 1, wherein the UL signal in the plurality of UL signals comprises a UL multiuser multiple-input multiple-output (UL-MU-MIMO) signal.

12. An apparatus for wireless communications, comprising:
means for receiving a plurality of uplink (UL) signals;
means for determining power of the received plurality of UL signals;
means for determining adjustment information for a UL signal in the plurality of UL signals based on at least the power of the received UL signals and a target carrier-to-interference (C/I) ratio; and
means for transmitting the adjustment information.

13. The apparatus of claim 12, wherein the means for receiving the plurality of UL signals is configured to receive a Request to Transmit (RTX) message or a physical layer convergence protocol (PLCP) protocol data unit (PPDU).

14. The apparatus of claim 12, wherein the adjustment information for the UL signal comprises a back-off value for a station (STA) that transmitted the UL signal.

15. The apparatus of claim 12, wherein the means for determining the adjustment information is configured to:
determine a maximum of the power of the received UL signals; and
determine the adjustment information for the UL signal based on the maximum power and the target C/I ratio.

16. The apparatus of claim 15, wherein the means for determining the adjustment information is configured to:
determine a thermal noise floor power; and
determine the adjustment information for the UL signal based on the maximum power, the target C/I ratio, and the thermal noise floor power.

17. The apparatus of claim 16, wherein the means for determining the adjustment information is configured to:
determine a maximum value between the maximum power of the received UL signals subtracted by a maximum back-off value and a sum of the thermal noise floor power and the target C/I ratio; and
subtract the maximum value from the received power of the UL signal to calculate the adjustment information for the UL signal.

18. The apparatus of claim 17, wherein the adjustment information is bounded by a lower bound of 0 and an upper bound equal to the maximum back-off value.

19. The apparatus of claim 17, wherein the maximum back-off value is about 40 dB.

20. The apparatus of claim 12, wherein the target C/I ratio is about 30 dB.

21. The apparatus of claim 12, wherein the means for transmitting the adjustment information is configured to transmit a Clear to Transmit (CTX) message with a field indicating the adjustment information for the UL signal.

22. The apparatus of claim 12, wherein the UL signal in the plurality of UL signals comprises a UL multiuser multiple-input multiple-output (UL-MU-MIMO) signal.

23. An access point (AP), comprising:
a receiver configured to receive a plurality of uplink (UL) signals;
logic for determining power of the received plurality of UL signals;
logic for determining adjustment information for a UL signal in the plurality of UL signals based on at least the power of the received UL signals and a target carrier-to-interference (C/I) ratio; and
a transmitter configured to transmit the adjustment information.

24. The access point of claim 23, wherein the receiver is configured to receive the plurality of UL signals by receiving a Request to Transmit (RTX) message or a physical layer convergence protocol (PLCP) protocol data unit (PPDU).

25. The access point of claim 23, wherein the adjustment information for the UL signal comprises a back-off value for a station (STA) that transmitted the UL signal.

26. The access point of claim 23, wherein the logic for determining the adjustment information is configured to:
determine a maximum of the power of the received UL signals; and
determine the adjustment information for the UL signal based on the maximum power and the target C/I ratio.

27. The access point of claim 26, wherein the logic for determining the adjustment information is configured to:
determine a thermal noise floor power; and
determine the adjustment information for the UL signal based on the maximum power, the target C/I ratio, and the thermal noise floor power.

28. The access point of claim 27, wherein the logic for determining the adjustment information is configured to:
determine a maximum value between the maximum power of the received UL signals subtracted by a maximum back-off value and a sum of the thermal noise floor power and the target C/I ratio; and
subtract the maximum value from the received power of the UL signal to calculate the adjustment information for the UL signal.

29. The access point of claim 28, wherein the adjustment information is bounded by a lower bound of 0 and an upper bound equal to the maximum back-off value.

30. The access point of claim 28, wherein the maximum back-off value is about 40 dB.

31. The access point of claim 23, wherein the target C/I ratio is about 30 dB.

32. The access point of claim 23, wherein the transmitter is configured to transmit the adjustment information by transmitting a Clear to Transmit (CTX) message with a field indicating the adjustment information for the UL signal.

33. The access point of claim 23, wherein the UL signal in the plurality of UL signals comprises a UL multiuser multiple-input multiple-output (UL-MU-MIMO) signal.

34. A computer-program product for wireless communications, comprising a computer-readable medium having instructions stored thereon, the instructions being executable by one or more processors and the instructions comprising:
instructions for receiving a plurality of uplink (UL) signals;
instructions for determining power of the received plurality of UL signals;
instructions for determining adjustment information for a UL signal in the plurality of UL signals based on at least the power of the received UL signals and a target carrier-to-interference (C/I) ratio; and
instructions for transmitting the adjustment information.

35. The computer-program product of claim 34, wherein the instructions for receiving the plurality of UL signals comprises instructions for receiving a Request to Transmit (RTX) message or a physical layer convergence protocol (PLCP) protocol data unit (PPDU).

36. The computer-program product of claim 34, wherein the adjustment information for the UL signal comprises a back-off value for a station (STA) that transmitted the UL signal.

37. The computer-program product of claim 34, wherein the instructions for determining the adjustment information comprises:
instructions for determining a maximum of the power of the received UL signals; and
instructions for determining the adjustment information for the UL signal based on the maximum power and the target C/I ratio.

38. The computer-program product of claim 37, wherein the instructions for determining the adjustment information comprises:
instructions for determining a thermal noise floor power; and
instructions for determining the adjustment information for the UL signal based on the maximum power, the target C/I ratio, and the thermal noise floor power.

39. The computer-program product of claim 38, wherein the instructions for determining the adjustment information comprises:
instructions for determining a maximum value between the maximum power of the received UL signals subtracted by a maximum back-off value and a sum of the thermal noise floor power and the target C/I ratio; and
instructions for subtracting the maximum value from the received power of the UL signal to calculate the adjustment information for the UL signal.

40. The computer-program product of claim 39, wherein the adjustment information is bounded by a lower bound of 0 and an upper bound equal to the maximum back-off value.

41. The computer-program product of claim 39, wherein the maximum back-off value is about 40 dB.

42. The computer-program product of claim 34, wherein the target C/I ratio is about 30 dB.

43. The computer-program product of claim 34, wherein the instructions for transmitting the adjustment information comprises instructions for transmitting a Clear to Transmit (CTX) message with a field indicating the adjustment information for the UL signal.

44. The computer-program product of claim 34, wherein the UL signal in the plurality of UL signals comprises a UL multiuser multiple-input multiple-output (UL-MU-MIMO) signal.
